(19) United States
(12) Patent Application Publication
(10) Pub. No.: US 2002/0054978 A1
(43) Pub. Date: May 9, 2002

(54) Cloth with a stabilizing support structure

(76) Inventors: Per Holmberg, Dalby (SE); Lars Eriksson, Emmaboda (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/954,247

(22) Filed: Sep. 17, 2001

Related U.S. Application Data
(60) Provisional application No. 60/256,809, filed on Dec. 18, 2000.

(30) Foreign Application Priority Data
Sep. 18, 2000 (SE) 0003323-3
Dec. 14, 2000 (SE) 0004621-9

(51) Int. Cl. B32B 3/06

(52) U.S. Cl. 428/99

(57) ABSTRACT

A cloth for covering an opening in the housing of electronic equipment includes a stabilizing support structure. The cloth is permeable to gases, especially air, but is impermeable to fluids, moisture, dirt, dust, particles and the like. The stabilizing support structure may have one or more bars or may be adjacent to or integrated in the cloth. The support may also be provided by a fixed edge of the opening that the cloth is stretched over.

### BACKGROUND

The present invention relates to a gas permeable cloth covering an opening in the housing of electronic equipment. The cloth covering the opening is stabilized by a supporting structure.

Cloths of the above kind are at present used in many different contexts. In this application the main use of the cloth is to keep out harmful substances and hinder the harmful substances from harming electronic or mechanical devices placed in connection to an opening of a housing of electronic equipment. The harmful substances may be different fluids, such as water, moisture, dust, dirt, particles, etc. Thus, the cloth should be impermeable to fluids, moisture, dust, dirt, particles, etc. At the same time the cloth should be permeable to gases, especially air. The devices to be protected by the cloth may be microphones and loudspeakers and, thus, the cloth should not hinder sound from going through. Furthermore, the cloth may be used to protect battery air inlets or inlets for other electronic units such as transmitters and receivers. One aim is to be able to use electronic equipment in harsh environments, such as at sea, outdoors, at building sites, in heavy industry, etc.

The term electronic equipment includes portable radio communication equipment, such as mobile telephones, pagers, communicators, i.e., electronic organizers, smartphones or the like.

It is not possible to use the cloths of the prior art to cover large openings. The large openings may be for large loudspeakers, ventilation means, computers and/or other electronic devices. When the cloth is stretched over a large opening the stress on the cloth is substantial. The cloth normally used is much too yielding, which means that it will not stand even small pressures or any kind of mechanical influence without being damaged. If the cloth is damaged it will not be able to fulfil its purpose. Furthermore, large cloths will be harder to fasten at the housing or frame. A larger cloth is heavier and the pressure or mechanical influence on the periphery, where the cloth is attached to the frame, will threaten to damage the periphery of the cloth, tearing it apart and making it lose its grip with the opening. The only possible solution according to the prior art is to have very thick and thus heavy cloths. In addition to the problems mentioned above such cloths are expensive. The cloths of the prior art used to cover small openings are also difficult to fasten at the edge of the opening.

### SUMMARY

One object of the present invention is to provide good support for cloths covering an opening of electronic equipment.

A further object is to simplify the mounting of the cloth in the opening of the housing or frame of the electronic equipment.

According to the invention, a stabilizing structure is formed, allowing the cloth to cover large openings without being harmed or being too yielding. The stabilizing structure may have many different designs such as a net, longitudinal or transversal bars, which may he crossed and/or overlapping, forming plates, rings, triangles, rectangles or any other form. The formations may be flat or may form a framework having one or more points of support bearing against the frame. The stabilizing structure may be formed by thickened parts of the cloth.

Furthermore, the cloth may be given a support by stretching the cloth and by fixing it in a stretched condition at the edges of the opening and/or at the points of support. If the cloth is made of an elastic material the stretched area will remain for a longer period of time compared to if the cloth is of a non-elastic material. Furthermore it will be easier to stretch an elastic cloth when mounting it over the opening. The support to the cloth may be provided by a combination of one or more of the above stated supports or stabilizing structures.

The stabilizing structure may be placed on either side of the cloth or may be integrated in the cloth. The stabilizing structure may be made of plastics, metal, wood or any other suitable material. Furthermore the cloth is furnished with means of attachment at least in one location on the surface or at the edge of the cloth. Thus, according to the invention, large cloths may be mounted over large openings, whereby the cloth is used to atop fluids such as water, moisture, dirt, dust and other particles but to let air and thus sound through. Furthermore, the cloth will withstand pressures and mechanical influences. All in harsh environments.

According to the invention, the cloth may be rather thin and have the same thickness throughout the part covering the opening. The cloth according to the invention is easy to mount as the stabilizing structure may be furnished with means of attachment, fixing the cloth in a proper way over the opening. The means of attachment may comprise snaps, barbs, screw joints, threads, seams, clamps, etc.

The openings may have many different forms, such as circular, oval, rectangular, polygonal, etc.

It should be emphasized that the term “comprises/comprising” when used in this description is taken to specify the presence of stated features, integers, steps or components but does not preclude the presence or addition of one or more other features, integers, steps, components or groups thereof.

### BRIEF DESCRIPTION OF THE DRAWINGS

The invention will be described in greater detail below with reference to the accompanying figures. In the figures,

FIG. 1 is a schematic perspective view illustrating a stabilizing structure placed under a cloth;

FIG. 2 illustrates a section of a part of the cloth and a part of a point of support;

FIG. 3 illustrates a section through a part of the cloth having a means of attachment fixed to a housing of electronic equipment;

FIG. 4 illustrates a section through a part of a cloth having an alternative means of attachment fixed to a housing of electronic equipment; and

FIG. 5 illustrates a section through a part of a cloth having an integrated stabilizing structure.

### DETAILED DESCRIPTION

In FIG. 1 one embodiment of the present invention is shown. A housing or frame 1 of electronic equipment such as a mobile telephone is shown. The housing 1 has an opening 2 for communication with either a microphone or a loudspeaker (not shown). The opening 2 is covered by a cloth 6, which is supported by a stabilizing structure 4. Stabilizing structure 4 has at least one means of attachment 3. The means of attachment 3 fix the stabilizing structure 4 to the housing 1 at the edge 5 of the opening 2. A person skilled in the art realizes that any number of means of attachment may be used in the shown embodiment the stabilizing structure 4 has crossed bars 7 forming a net.

The stabilizing structure 4 may be placed on either side of the cloth 6. When the stabilizing structure 4 is placed on top of the cloth 6, the cloth 6 is normally fixed to the stabilizing structure 4 by means of glue, welding, etc. A stabilizing structure 4 on top of the cloth 6 will function as an impact protection.

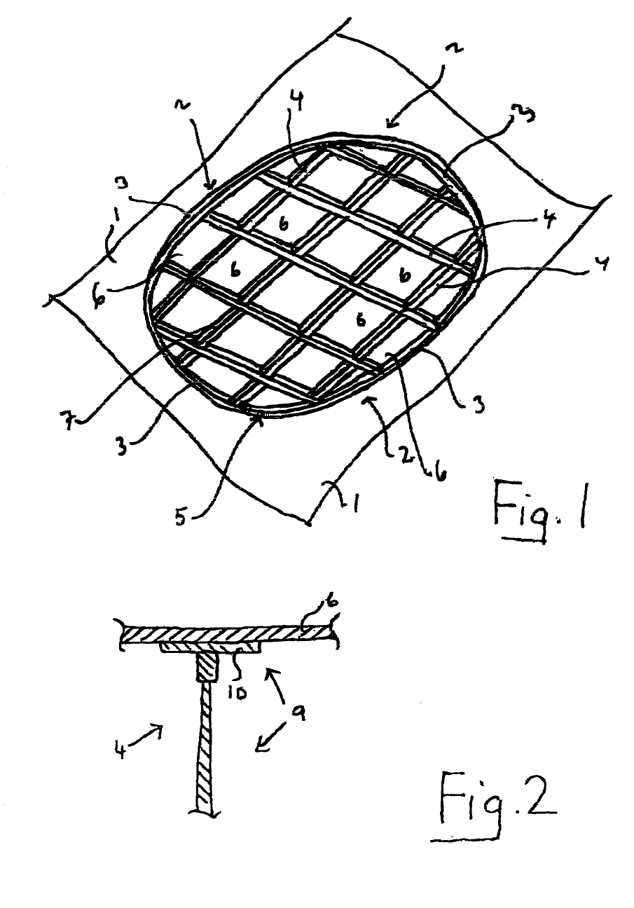

A structure forming a point of support 9 is shown in FIG. 2. On top of the point of support 9 a plate 10 receives the cloth 6. The plate 10 of the point of support 9 may also receive a bar 7 of the stabilizing structure 4. Thus, the point of support 9 will take up a part of the load of the cloth 6 and/or stabilizing structure 4. Normally a number of points of support 9 are arranged. The plate 10 will help to distribute the load on a large part of the cloth 6, reducing the risk of mechanical influence on the cloth 6. The point of support 9 is integrated with or supported in the housing 1.

The cloth 6 is held at the edge 5 of the opening 2 by a means of attachment 3. In the embodiment of FIG. 3 the means of attachment 3 comprise a male part 11 and a female part 12. The male part 11 is fixed to the cloth 6, by clamping the edge 14 of the cloth 6. The male part 11 clamping the cloth 6 is received in the female part 12. The male part 11 is assembled in a mainly horizontal direction in the female part 12. The male part 11 may be elastic to snap into the female part 12. A gasket 15 is arranged between the male and female parts 11, 12. The function of the gasket 15 is to hinder fluids and moisture to come into the electronic equipment at the means of attachment 3.

Depending on the size of the opening 2, the only stabilizing structure may be the way the cloth 6 is attached to the edge 5 of the opening 2. The cloth 6 is normally stretched at the assembly. However, for larger openings further stabilizing structures 4, including one or more points of support, are arranged.

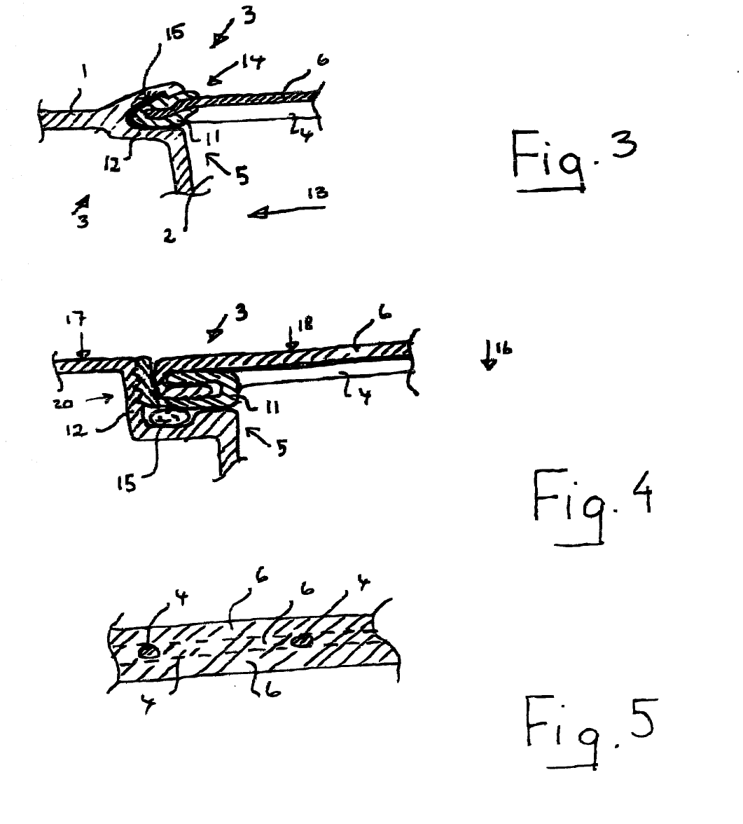

In the embodiment of FIG. 4 the edge 14 of the cloth 6 is folded into a slit of the male part 11. The cloth 6 may he held at the male part 11 by means of glue, welding, friction and/or that the male part 11 is pretensioned to give a clamping force on the cloth 6. In this embodiment the female part 12 is actually a part of the housing 1 and has two perpendicular surfaces, one of which has a recess for receiving a gasket 15. The gasket 15 seals between the male and female parts 11, 12.

The male part 11 is held at the female part 12 in that barbs, cuts, grooves or the like 20 of respective part lock into each other. In other embodiments, the male and female parts 11, 12 are attached to each other by means of an adhesive, by welding or the like. The male part 11 has an outer contour corresponding to the inner contour of the female part 12. In a further embodiment, the outer dimension of the male part 11 is slightly larger than the inner dimension of the female part 12, which allows a force fit to provide a stronger connection.

In the embodiment of FIG. 5 the stabilizing structure 4 is received inside the cloth 6. This is done by means of bars 7 interwoven into the cloth 6, or by having channels in the cloth, which channels will receive bars 7. The edge 14 of the cloth 6 is attached to the edge 5 of the opening 2 in any of the above ways. A person skilled in the art realizes that even if a cloth 6 having enclosed bars 7 is used the other stabilizing structures 4 may be used, including one or more points of support 9.

It should be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

Various embodiments of Applicants' invention have been described, but it will be appreciated by those of ordinary skill in this art that these embodiments are merely illustrative and that many other embodiments are possible. The intended scope of the invention is set forth by the following claims, rather than the preceding description, and all variations that fall within the scope of the claims are intended to be embraced therein.

What is claimed is:

1. A cloth for covering an opening in a housing of electronic equipment, said cloth being permeable to air but impermeable to fluids, moisture, dirt, and dust, said cloth further comprising a stabilizing support structure.

2. The cloth of claim 1, wherein stabilizing support structure includes one or more bars and is located adjacent to either side of the cloth or is integrated within layers of the cloth.

3. The cloth of claim 1, wherein the stabilizing support structure is provided at least in part by at least one fixed edge of the opening and the cloth is stretched over the opening.

4. The cloth of claim 3, wherein the cloth is fixed to the edge of the opening by a means of attachment comprising a male part and a female part.

5. The cloth of claim 1, wherein the cloth and/or the stabilizing support structure is supported in one or more points of support.

6. The cloth of claim 5, wherein the one or more points of support includes a plate for contact with the cloth or the stabilizing structure and the point of support is supported in the housing of the electronic equipment.

7. The cloth of claim 4, wherein a gasket is interposed between the male part and the female part and the edge of the cloth is received in the male part.

8. The cloth of claim 7, wherein the male part is clamped on the edge of the cloth.

9. The cloth of claim 7, wherein the edge of the cloth is received in a slit of the male part.

10. The cloth of claim 4, wherein the female part encloses the male part at assembly.

11. The cloth of claim 4, wherein that the male part and female part are connected by means of welding, an adhesive, barbs, cuts or grooves.

12. The cloth of claim 1, wherein the stabilizing support structure is interwoven into the cloth.

13. The cloth of claim 1, wherein the bars are situated in channels of the cloth to forms the stabilizing support structure.

14. The cloth of claim 1, wherein the stabilizing support structure is formed by thickened parts of the cloth.

15. The cloth of claim 1, wherein the electronic equipment is a mobile telephone.

16. The cloth of claim 1, wherein the cloth is comprised of an elastic material.
